(19) United States
(12) Patent Application Publication
(10) Pub. No.: US 2008/0204232 A1
(43) Pub. Date: Aug. 28, 2008

(54) ENHANCED SYSTEM FOR TRACKING IMPORTANT TRAVEL ITEMS INCLUDING VERIFYING DYNAMIC PROHIBITIONS OF PACKED ITEMS

(76) Inventors: Kavita Agrawal, Austin, TX (US); William Kress Bodin, Austin, TX (US); Lakshmi Potluri, Austin, TX (US); Gregory Rybczynski, Pflugerville, TX (US)

Correspondence Address: IBM CORPORATION (RHF), C/O ROBERT H. FRANTZ, P. O. BOX 23324, OKLAHOMA CITY, OK, 73123, US

(21) Appl. No.: 11/679,198

(22) Filed: Feb. 27, 2007

(51) Int. Cl. G08B 13/14

(52) U.S. Cl. 340/572.1

(57) ABSTRACT

A system for checking travel bag for important items by applying an RFID tag to each of a plurality of items, each RFID tag having a unique identifier, storing a list of items and associated RFID tag identifiers in a data store, receiving a user selection of important items for a particular trip, transferring a subset of said plurality of items to a portable computing device, using the portable computing device to scan the RFID tags on the user's packed items, determining if any important items are missing, and displaying a warning to the user if any item from the list is not found. Additionally, the containers are each provided an RFID tag to indicate location of each packed item, and the system accesses one or more jurisdictional restrictions lists, verifies proper location of restricted items and absence of prohibited items, and warns the user of any violations.

### CROSS-REFERENCE TO RELATED APPLICATIONS (CLAIMING BENEFIT UNDER 35 U.S.C. 120)

None.

### FEDERALLY SPONSORED RESEARCH AND DEVELOPMENT STATEMENT

This invention was not developed in conjunction with any Federally sponsored contract.

### MICROFICHE APPENDIX

Not applicable.

### INCORPORATION BY REFERENCE

None.

### BACKGROUND OF THE INVENTION

1. Field of the Invention

The present invention relates generally to a system and method for allowing a traveler to designate important items to be taken during traveling, and for verifying that those items are properly packed or unpacked by verifying bag contents against one or more travel lists.

2. Background of the Invention

Traveling is an integral part of many peoples lives. Some items are more important that others because they are not easily replaced or substituted while traveling. It is a common scenario where one forgets or overlooks packing some important things for a trip.

Some important items are difficult or expensive to replace for use during the trip, while others are impossible to replace. For example, there are often times when one forgets a phone or laptop computer charger, a prescription medication, or an important travel document such as a passport.

Each time a traveler packs or unpacks his or her suitcases, brief case, bag, etc., the same error may occur. For example, a traveler initially packs everything that is needed for a trip which will involve stays at two or more hotels. Upon arriving at the first hotel, he or she unpacks everything, and uses it during the first “leg” of the trip. Then, in preparation to travel to the second hotel, the traveler re-packs all of his or her belongings, except for a missed important item.

Some items are important or unimportant depending on the nature of a trip, while others are always important for a trip. For example, a laptop and its charger is important if the trip will require its use, but otherwise it may be optional. However, a traveler's asthma medication may always be important regardless of the destination or trip purpose (pleasure, business, etc.). As such, failing to pack some important items can have serious consequences to health, safety, and the well being of the traveler.

To add to this problem is the fact that many modes of travel include passage through security-controlled facilities such as airports, train stations, and border entry points. The list of prohibited items for a traveler or passenger to include in his or her “carry on” bag may be significantly different from a list of prohibited items to be packed in “checked” bags. So, while an item may be important to take on a trip, it may be equally important that the item be placed in the correct bag (e.g. to be checked or carried on) to avoid confiscation, damage or loss of the item.

Further exasperating this problem is the dynamic nature of such security prohibited item requirements. Due to conditions nationally and globally regarding safety, terrorism, and law enforcement activities, conditions which are subject to change often drive immediate changes in security procedures. These security procedures may be adopted nationally or internationally, or may vary from country to country. So, a traveler must also be cognizant of the travel item restrictions and guidelines for every country or jurisdiction at the time of packing his or her bags, which may have literally changed “overnight”.

This problem is even more evident under two scenarios of travel. In the first scenario, the traveler is fully aware and compliant with security policies at the outset of the trip, but during the trip, security policies change. This can make it difficult for the traveler to be aware of the policy change, and to comply with the policy during subsequent legs of the trip or on the return trip home.

Further, however, some travel itineraries involve the traveler “touching down” or visiting only temporarily an intermediate jurisdiction. For example, a traveler from the USA is making a trip to India, but on the route from the USA to India is required to land, deplane, and board another plane in the United Kingdom. Thus, if the traveler is not aware of current security requirements in the USA, United Kingdom, and India, he or she may be detained or delayed, and important travel items may be confiscated, discarded, or otherwise rendered unavailable to the traveler.

On a return trip, it is not uncommon for such an international traveler to make a different intermediate stop, such as the foregoing example traveler being routed home from India to the USA by way of a plane change in Germany. So, in this example, the traveler would first need to be aware of all packing guidelines and restrictions for the USA, United Kingdom, and India at the time of departure, and then also be aware of all packing guidelines and restrictions for India, Germany, and the USA at the time of returning, all while remembering to pack all important items which are important for personal or business reasons, as well.

### SUMMARY OF THE INVENTION

The present invention provides a system, a computer-readable media with software, and an automated method for checking travel bag for important items by applying an RFID tag to each of a plurality of items, each RFID tag having a unique identifier, storing a list of items and associated RFID tag identifiers in a data store, receiving a user selection of important items for a particular trip, transferring a subset of said plurality of items to a portable computing device, using the portable computing device to scan the RFID tags on the user's packed items, determining if any important items are missing, and displaying a warning to the user if any item from the list is not found. Additionally, the containers are each provided an RFID tag to indicate location of each packed item, and the system accesses one or more jurisdictional restrictions lists, verifies proper location of restricted items and absence of prohibited items, and warns the user of any violations.

### BRIEF DESCRIPTION OF THE DRAWINGS

The following detailed description when taken in conjunction with the figures presented herein provide a complete disclosure of the invention.

FIG. 1 depicts a logical process of using the present invention.

FIGS. 2a and 2b show a generalized computing platform architecture, and a generalized organization of software and firmware of such a computing platform architecture.

FIG. 3a sets forth a logical process to deploy software to a client in which the deployed software embodies the methods and processes of the present invention.

FIG. 3b sets forth a logical process to integrate software to other software programs in which the integrated software embodies the methods and processes of the present invention.

FIG. 3c sets for a logical process to execute software on behalf of a client in an on-demand computing system, in which the executed software embodies the methods and processes of the present invention.

FIG. 3d sets for a logical process to deploy software to a client via a virtual private network, in which the deployed software embodies the methods and processes of the present invention.

FIGS. 4a, 4b and 4c, illustrate computer readable media of various removable and fixed types, signal transceivers, and parallel-to-serial-to-parallel signal circuits.

FIG. 5 shows a logical process according to the invention.

FIG. 6 illustrates details of interoperation of a read-equipped pervasive computing device with an RFID tag on an important travel item.

FIG. 7 sets forth a generalized logical process of operating the present invention.

FIG. 8 sets forth a logical process according to the invention including verification of the contents of travel containers against one or more travel restrictions lists.

FIGS. 9a-9c illustrate alternative component interactions according to the present invention for providing verification of the contents of travel containers against one or more travel restrictions lists.

### DETAILED DESCRIPTION OF THE INVENTION

The inventors of the present invention have recognized a problem unaddressed in the art regarding tracking important items during travel, and especially when packing for a trip.

For convenience of the reader, we will first review some technology terms which will be used in the present disclosure. Radio Frequency Identification (“RFID”) is a technology already deployed to track products, and even livestock and pets, especially for the prevention of theft, which includes a small transponder packaged in a specific manner. For example, for tracking a live animal, the transponder is packaged in a small biologically-save enclosure which can be inserted under the skin of the animal. For products, RFID tags may appear to be flat decals having a coiled metalic strip in them, a small rectangular plastic strip, or other unobstrusive package which can be easily adhered to the outside or the inside of the product or its package.

Generally speaking, RFID tags typically do not have their own power source, but some units do. Normally, when an RFID tag is in the presence of a certain radio frequency signal, it induces a small amount of energy from the signal, powers a small transmitter chip, and then transmits a unique code or value which can be decoded to usually include an indication of the manufacturer of the product, a model of the product, and a unique serial number of the tag. This operation allows the tags to be inexpensive, and to interoperate with readers, such as anti-theft gates at retail store exits and point-of-sale cash registers. Some RFID tags can also receive a signal to deactivate them.

Many manufactures currently affix RFID tags to their products at the time of packaging or manufacture for the convenience of their retailers and distributors. Many consumers do not remove these tags after purchase, either through lack of knowledge that they are there, or through lack of desire to remove them.

Throughout the following disclosure, we will refer to RFID and RFID tags inclusively for all types of technologies and devices which operate in this manner, regardless of encoding scheme, RF band of operation, being self-powered or inductively powered, or method of affixing or associating the RFID tag to a product or item.

Pervasive computing devices (“PCD”) are a family of portable, networked devices such as “smart” cellular telephones, personal digital assistants (“PDA”), pocket personal computers, and even laptop personal computers (“laptop PC”). Throughout this disclosure, we will refer to all such portable devices inclusively as PCD's.

Secure Data Identification (“SDiD”) is a device which interfaces a PCD with an RFID tag. It typically fits into a memory card slot of the PCD intended for a device such as a Secure Digital (“SD”) card, but also includes circuitry and antennae for sending and receiving signals to and from RFID tags and devices. Other form factors of such an RFID interface for PCD are possible, including other memory card slot form factors (e.g. PCMCIA, PC bus, CompactFlash, Sony MemoryStick™, Universal Serial Bus, etc.), as well as proprietary form factors. Throughout this disclosure, we will refer to all such RFID interface devices inclusively for computing platforms and PCD as SDiD, regardless of form factor.

### Scenario of Use

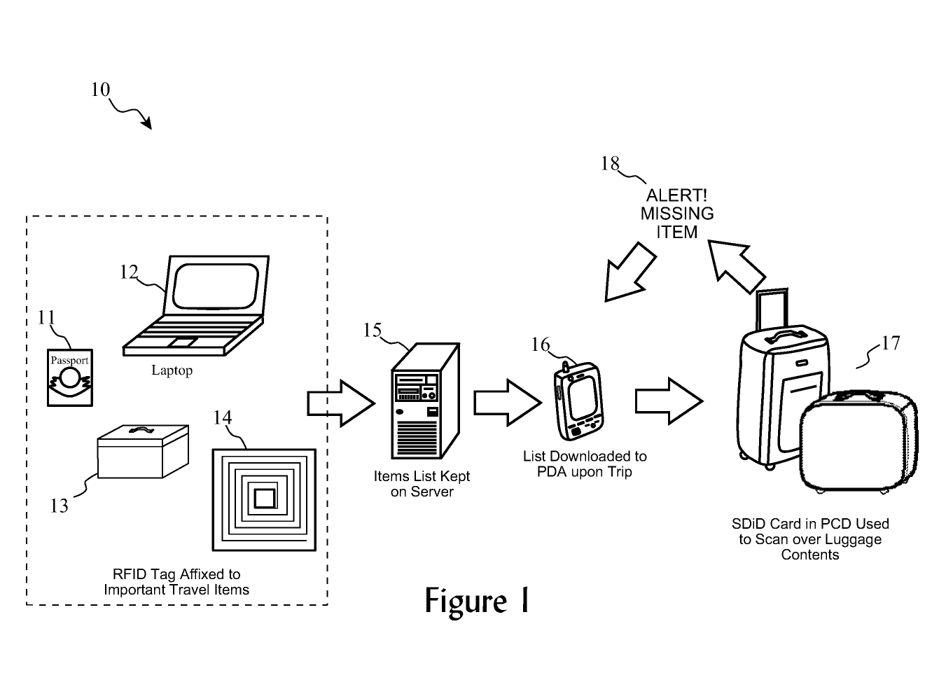

The present invention provides a unique way of solving the foregoing problems in the art. First, consider a scenario as illustrated (10) in FIG. 1, where a traveler is destined for a conference that will be a three-hour drive. Anytime this traveler needs to go on a business-related trip, there are a couple of things that are mandatory, for example:

(a) the traveler's passport (11);

(b) a laptop computer (12); and

(c) a specific medication (13).

For ease of understanding, this example is limited to three important items, but in practice, there is no limitation to the number of items the invention can track.

Some of these items may already be individually tagged (14) by the retailer or manufacturer, or the user/traveler may add a tag after purchasing the item.

These important items are added to a user's list on a server (15), such as a personal computer or web server. For ease of entry, the traveler may use an SDiD-equipped PCD (16) to scan the RFID tags to enter the unique identification numbers of each item into his or her list, or he or she may enter the identification numbers manually.

Once the items are placed on a “must have item list”, the system can assist the user in making sure the items are with him or her upon departure. According to an embodiment of the invention, each user can have multiple must-have lists, potentially sorted and categorized by trip type (e.g. business, pleasure, vacation, educational, emergency, etc.), by destination (e.g. out of town, out of state, out of country, etc.), by mode of transportation (e.g. private car, plane, train, taxi, etc.), and each item on a list may be categorized by degree of importance (e.g. critical, preferred, optional, etc.).

Further, each user is optionally provided with sets of lists based on the origin of their trip, such as leaving from the office or leaving from home. And, each item can appear on one or many lists.

Once the tagged items (11, 12, 13) are listed in the server, this list is associated with a PCD (16) which is equipped with a tag reader, such as an SDiD card. Subsequently, such as when the traveler's calendar identifies that he or she is traveling, the user is enabled to use the mobile device which has downloaded or retrieved the appropriate important items list from the server (15).

During packing of his or her suitcases, bags, briefcase, etc. (17), the user may review the list as a reminder list. Then, when the user believes packing is complete, he or she may scan the bag and the items in it. The reader-equipped PCD then verifies that all listed items are physically present in the bag(s), and if not, the user is alerted (18) to the missing items.

Through this general method of use of the invention, several advantages are realized:
1. It can be extremely useful for senior citizens who may need some crucial items on a trip especially specialized medication that may not be easily accessible.
2. It is very convenient for those with families and children for whom packing must be done by a guardian or parent.
3. Stress of trip preparation is reduced by allowing less worry about packing all the essentials.
4. Travel costs are reduced by reducing the number of forgotten items which must be purchased upon discovery of their absence after arriving at a travel destination.

### Logical Processes

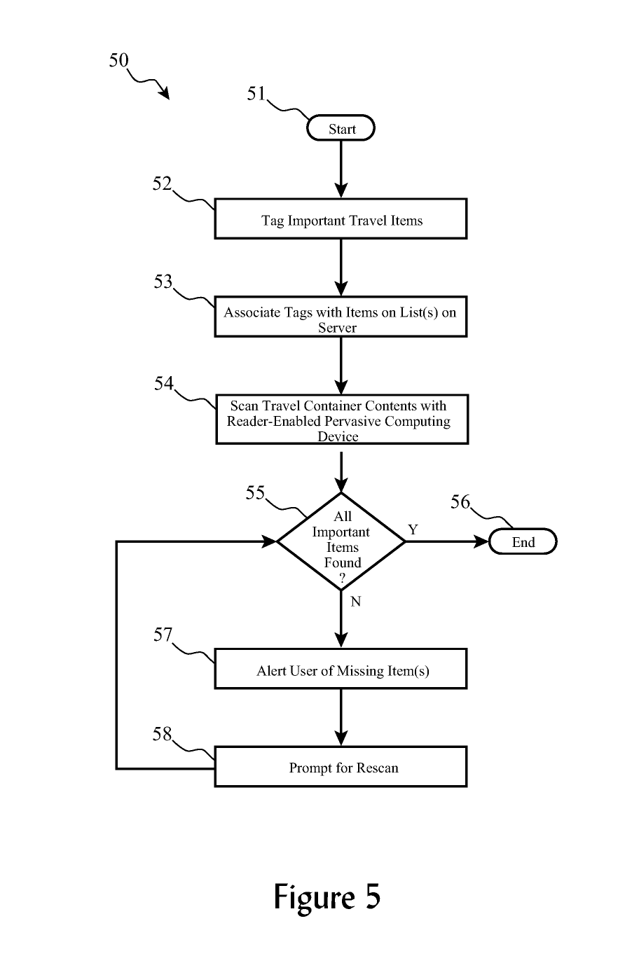

Turning to FIG. 5, a logical process (50) according to the invention is shown in which the user or traveler starts (51) by making sure each important item is tagged with an RFID tag (52). If any items do not already have a tag, the user may select a tag and affix it to the item.

Then, the user adds the item description and the item's tag identifier to one or more travel item lists maintained by the user's server (53). This server may be a web-based server which the user accesses through a browser, or it may be a program on the user's own personal computer or PCD, for example.

Subsequently, when the user believes packing of one or more travel containers (e.g. suitcases, bags, brief cases, boxes, cartons, etc.), the user employs his or her reader-equipped pervasive computing device (e.g. cell phone, PDA, laptop PC, etc.) to scan (54) the contents of the travel containers, selecting a particular travel list from a plurality of lists if necessary.

The PCD, or alternatively the server in cooperation with the PCD, then verifies that all of the listed important items are found in the scanning process (55). If so, then the user is notified that all seems to be present (56). Otherwise, if an item is determined to be missing, the user is notified (57). After the user has packed the missing item, modified the list, or both, then scanning can be repeated (58).

This process can be repeated as many times as necessary until the travel containers' contents and the travel item lists concur with each other.

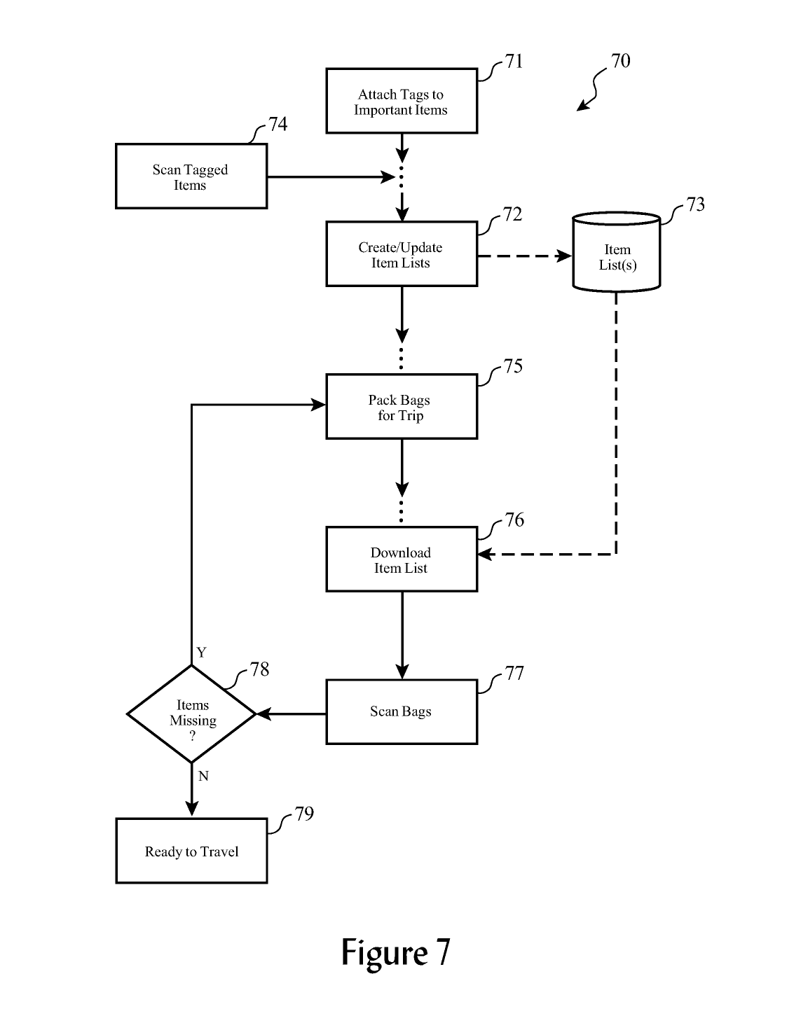

FIG. 7 provides an generalized view of a logical process (70) according to the invention and as illustrated by the foregoing example, including attaching tags to important travel items (71), and then creating (72) one or more travel item lists (73) including tag identifiers and item descriptions of important tagged items (74). Subsequently, the user packs (75) one or more travel containers for a trip, downloads (76) the appropriate important travel item list (73), scans (77) the contents of the travel containers, and corrects any deficiencies (78) by packing any missing items (75), modifying the relevant list, or both, until the contents of the travel containers match the list(s). Then, the user is notified that the containers are ready for travel (79).

### RFID Tags and Reader-Equipped PCD

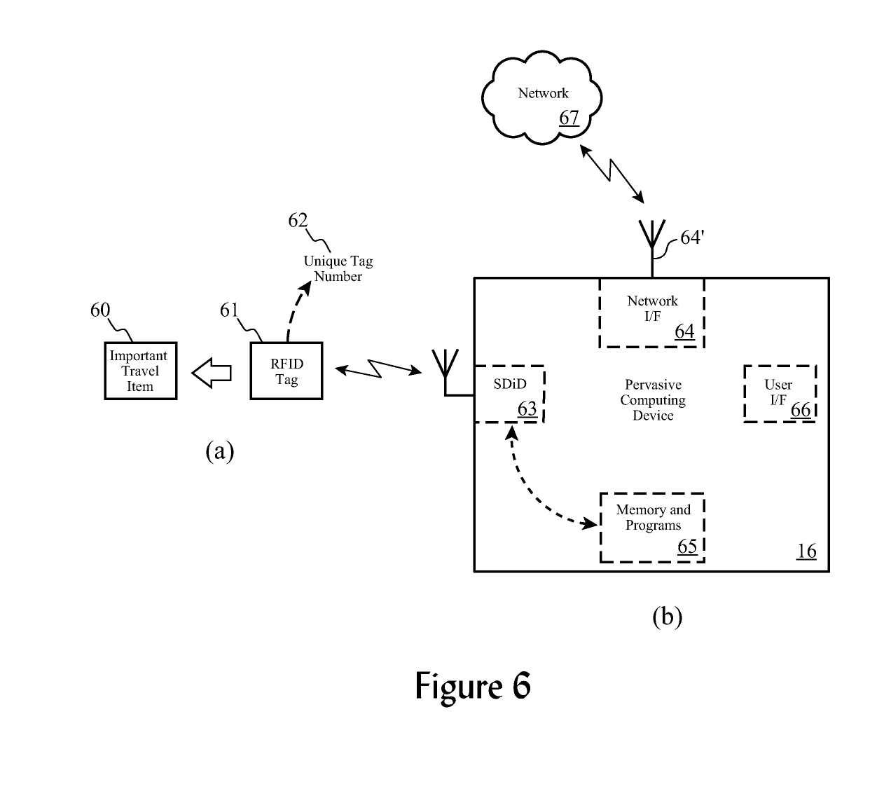

For better understanding of the components of the system according to the present invention, FIG. 6 illustrates how an important travel item (60), such as a battery charger, medication, document (passport, ID badge, credential, credit cards, etc.), medical device (breathing apparatus, back support, etc.), electronic instrument (clock, sound machine, etc.), or appliance (razor, curling iron, clothes iron, etc.), is associated by affixing an RFID tag (61) to it. In many cases, items already will have RFIDs on them as affixed by the retailer or manufacturer. However, for those items that do not have a tag, one method of practicing the invention includes providing extra RFID tags which can be affixed to items. The method of attaching the tags to the item can be any suitable means, such as through self-adhesive pressure, or through use of plastic tie wraps (e.g. “cable ties”). Each tag has a specific tag number (62) which is then associated in one or more travel item lists with a description of the item.

As for the pervasive computing device (16), such as a cell phone, PDA or laptop computer, it is prerferably equipped with a SDiD (63) device and appropriate software programs (65) which allows it to read tags (61) on items (60), as well as to communicate via a network (64, 64′, 67) to a server to verify one or more travel item lists. The PCD (16) also may use any variety of user interfaces (16), such as a color screen, audible beeper or buzzer, or LED indicators, to communicate to the user the status of the scan and check.

### Verification of Proper Packing of Prohibited or Restricted Travel Items

Further according to the present invention, an embodiment includes the functionality to assist a traveler in the proper packing of restricted travel items or avoidance of packing of prohibited travel items.

In order to verify proper packing of restricted travel items, such as packing items in bags to be checked which are not allowed to be carried on to an airplane or train, the user may optionally affix an RFID tag to the travel containers themselves. This allows the system to not only collect an inventory of the tagged items which are packed, but to also collect information as to their location (e.g. checked bag, carry on bag, etc.).

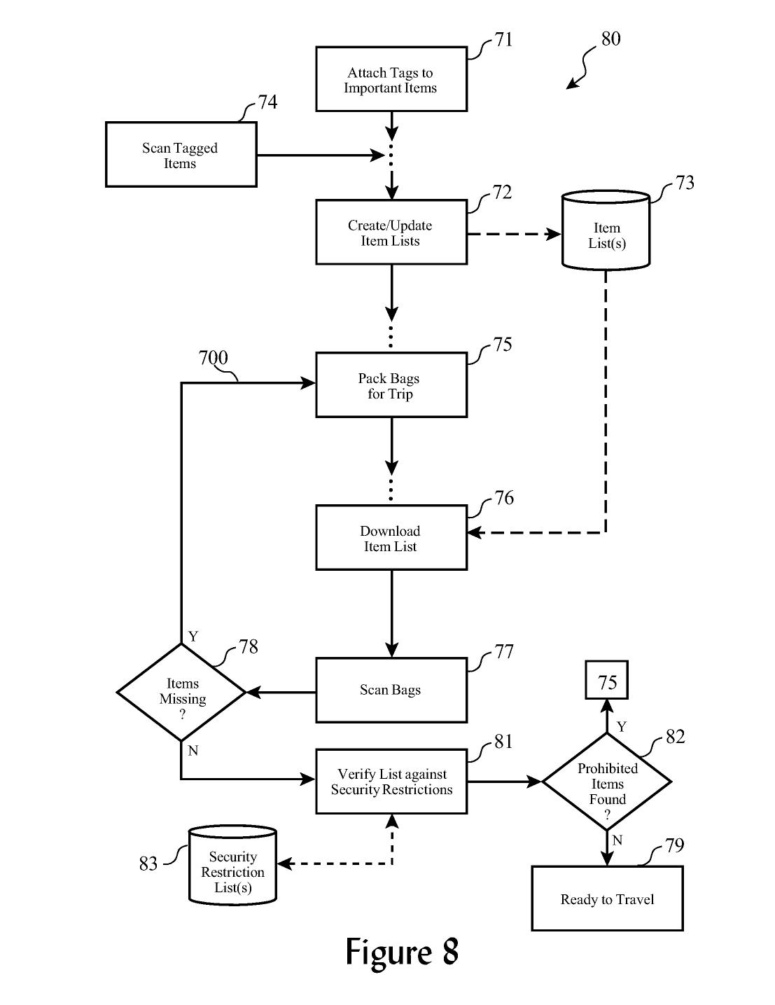

FIG. 8 shows a logical process variation of that of FIG. 7 which further includes verification (81) of the scanned inventory with a list of security restricted or prohibited items (83). If any prohibited items are found in any containers, or if any restricted items are found in disallowed containers (82), the user is prompted as to the problems so that he or she may re-pack (75) those items. The verification and re-packing steps may be repeated as many times as necessary until the user's travel containers are ready to travel (79).

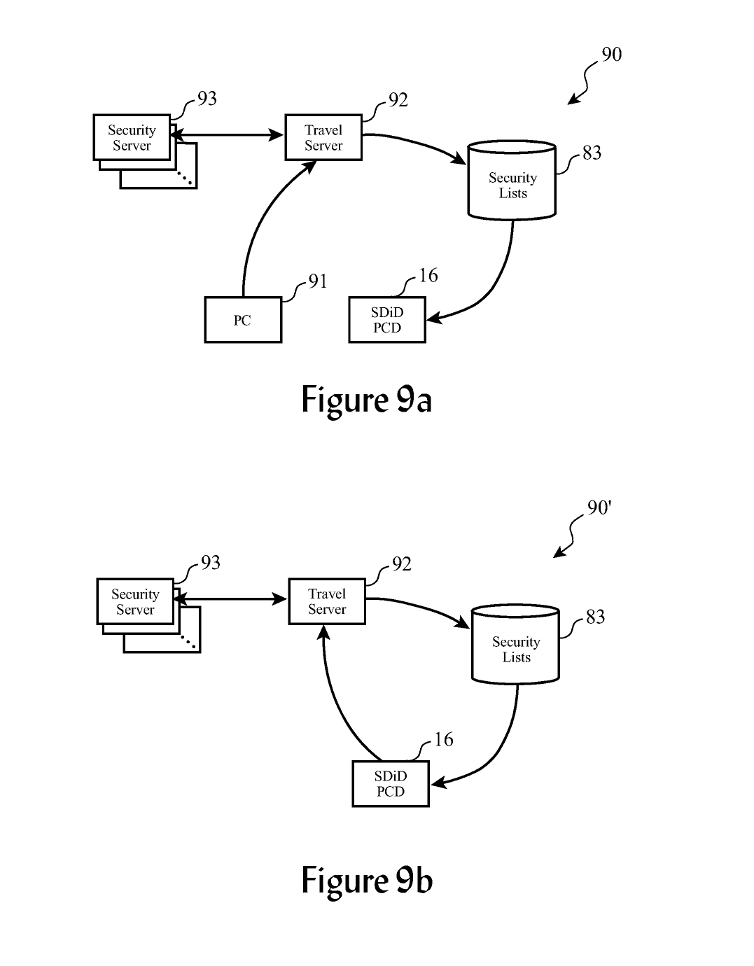

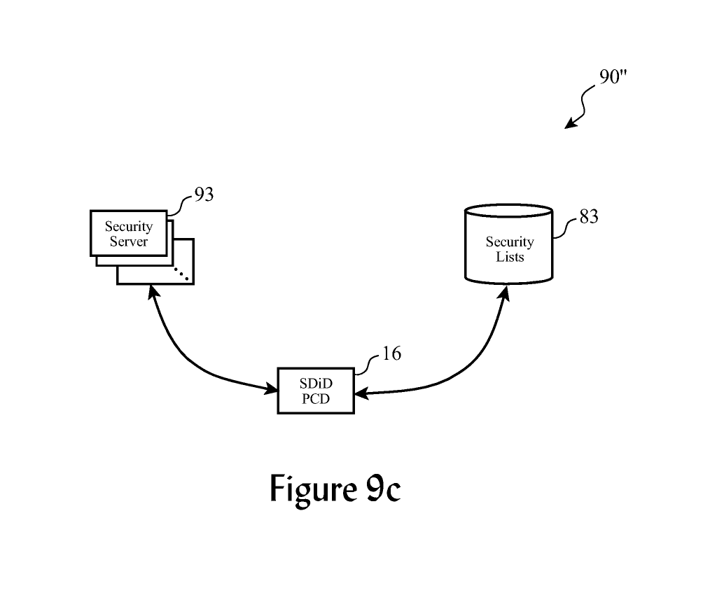

There are several methods available to integrate the security policy checking functionality of the present invention, due to the extended capabilities of the server (92), a user's PC (91), and the user's PCS (16), as shown in FIGS. 9a-9c. In FIG. 9a, for example, one embodiment includes the user's PC (91) communicating travel itinerary details, such as destination jurisdictions and possible intermediate points of inspection, to a travel server (92). The travel server (92) in this embodiment variation coordinates with one or more jurisdictional security servers (93), such as a server or web site operated by the US Transportation Security Agency or similar foreign agency, to obtain an up-to-date list of travel item prohibitions and restrictions. This information is then loaded into one or more security lists (83), which are then downloaded to the user's reader-equiped PCD (16) for use during container content verification.

Alternatively, as shown in FIG. 9b, depending on the technical capabilities of the user's PCD (16), it may directly interface to the travel server (92) to accomplish the same operations. A user who is traveling without a laptop PC may find this configuration useful, as it allows the user's reader-equipped PDA or cell phone to obtain the most current security restrictions, thereby avoiding costly and lengthy flight or train check in problems.

Further, if the technical capabilities of the user's PCD are sufficient, another embodiment allows for the PCD to perform all of these functions, contacting one or more jurisdictional security servers directly, and maintaining the security lists locally, as shown in FIG. 9c.

### Suitable Computing Platform

In one embodiment of the invention, the functionality of the invention, including the previously described logical processes, are performed in part or wholly by software executed by a computer, such as personal computers, web servers, web browsers, or even an appropriately capable portable computing platform, such as personal digital assistant (“PDA”), web-enabled wireless telephone, or other type of personal information management (“PIM”) device.

Therefore, it is useful to review a generalized architecture of a computing platform which may span the range of implementation, from a high-end web or enterprise server platform, to a personal computer, to a portable PDA or web-enabled wireless phone.

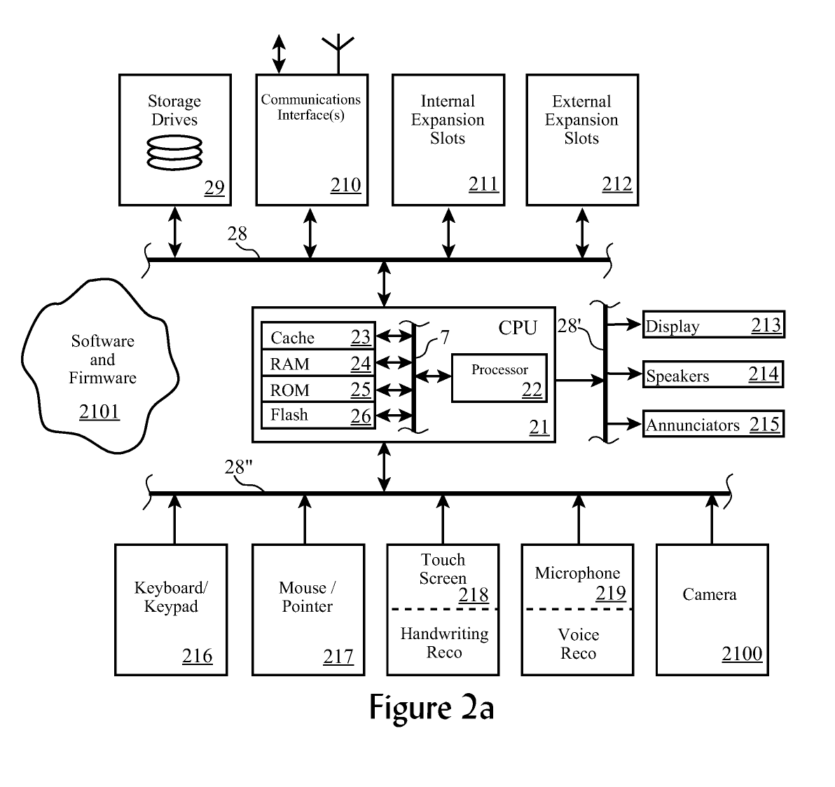

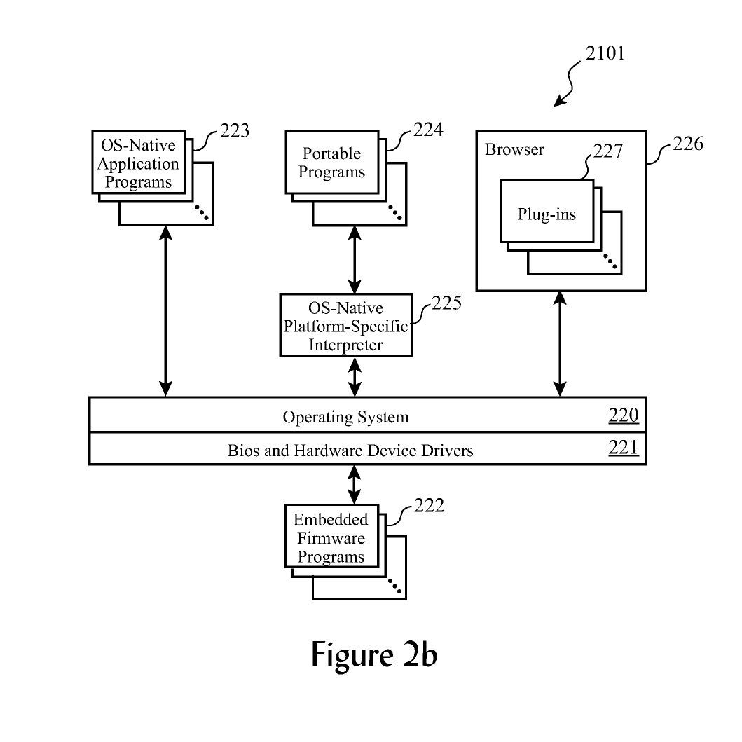

Turning to FIG. 2a, a generalized architecture is presented including a central processing unit (21) (“CPU”), which is typically comprised of a microprocessor (22) associated with random access memory (“RAM”) (24) and read-only memory (“ROM”) (25). Often, the CPU (21) is also provided with cache memory (23) and programmable FlashROM (26). The interface (27) between the microprocessor (22) and the various types of CPU memory is often referred to as a “local bus”, but also may be a more generic or industry standard bus.

Many computing platforms are also provided with one or more storage drives (29), such as hard-disk drives (“HDD”), floppy disk drives, compact disc drives (CD, CD-R, CD-RW, DVD, DVD-R, etc.), and proprietary disk and tape drives (e.g., Iomega Zip™ and Jaz™, Addonics SuperDisk™, etc.). Additionally, some storage drives may be accessible over a computer network.

Many computing platforms are provided with one or more communication interfaces (210), according to the function intended of the computing platform. For example, a personal computer is often provided with a high speed serial port (RS-232, RS-422, etc.), an enhanced parallel port (“EPP”), and one or more universal serial bus (“USB”) ports. The computing platform may also be provided with a local area network (“LAN”) interface, such as an Ethernet card, and other high-speed interfaces such as the High Performance Serial Bus IEEE-1394.

Computing platforms such as wireless telephones and wireless networked PDA's may also be provided with a radio frequency (“RF”) interface with antenna, as well. In some cases, the computing platform may be provided with an infrared data arrangement (“IrDA”) interface, too.

Computing platforms are often equipped with one or more internal expansion slots (211), such as Industry Standard Architecture (“ISA”), Enhanced Industry Standard Architecture (“EISA”), Peripheral Component Interconnect (“PCI”), or proprietary interface slots for the addition of other hardware, such as sound cards, memory boards, and graphics accelerators.

Additionally, many units, such as laptop computers and PDA's, are provided with one or more external expansion slots (212) allowing the user the ability to easily install and remove hardware expansion devices, such as PCMCIA cards, SmartMedia cards, and various proprietary modules such as removable hard drives, CD drives, and floppy drives.

Often, the storage drives (29), communication interfaces (210), internal expansion slots (211) and external expansion slots (212) are interconnected with the CPU (21) via a standard or industry open bus architecture (28), such as ISA, EISA, or PCI. In many cases, the bus (28) may be of a proprietary design.

A computing platform is usually provided with one or more user input devices, such as a keyboard or a keypad (216), and mouse or pointer device (217), and/or a touch-screen display (218). In the case of a personal computer, a full size keyboard is often provided along with a mouse or pointer device, such as a track ball or TrackPoint™. In the case of a web-enabled wireless telephone, a simple keypad may be provided with one or more function-specific keys. In the case of a PDA, a touch-screen (218) is usually provided, often with handwriting recognition capabilities.

Additionally, a microphone (219), such as the microphone of a web-enabled wireless telephone or the microphone of a personal computer, is supplied with the computing platform. This microphone may be used for simply reporting audio and voice signals, and it may also be used for entering user choices, such as voice navigation of web sites or auto-dialing telephone numbers, using voice recognition capabilities.

Many computing platforms are also equipped with a camera device (2100), such as a still digital camera or full motion video digital camera.

One or more user output devices, such as a display (213), are also provided with most computing platforms. The display (213) may take many forms, including a Cathode Ray Tube (“CRT”), a Thin Flat Transistor (“TFT”) array, or a simple set of light emitting diodes (“LED”) or liquid crystal display (“LCD”) indicators.

One or more speakers (214) and/or annunciators (215) are often associated with computing platforms, too. The speakers (214) may be used to reproduce audio and music, such as the speaker of a wireless telephone or the speakers of a personal computer. Annunciators (215) may take the form of simple beep emitters or buzzers, commonly found on certain devices such as PDAs and PIMs.

These user input and output devices may be directly interconnected (28′, 28″) to the CPU (21) via a proprietary bus structure and/or interfaces, or they may be interconnected through one or more industry open buses such as ISA, EISA, PCI, etc.

The computing platform is also provided with one or more software and firmware (2101) programs to implement the desired functionality of the computing platforms.

Turning to now FIG. 2b, more detail is given of a generalized organization of software and firmware (2101) on this range of computing platforms. One or more operating system (“OS”) native application programs (223) may be provided on the computing platform, such as word processors, spreadsheets, contact management utilities, address book, calendar, email client, presentation, financial and bookkeeping programs.

Additionally, one or more “portable” or device-independent programs (224) may be provided, which must be interpreted by an OS-native platform-specific interpreter (225), such as Java™ scripts and programs.

Often, computing platforms are also provided with a form of web browser or micro-browser (226), which may also include one or more extensions to the browser such as browser plug-ins (227).

The computing device is often provided with an operating system (220), such as Microsoft Windows™, UNIX, IBM OS/2™, IBM AIX™, open source LINUX, Apple's MAC OS™, or other platform specific operating systems. Smaller devices such as PDA's and wireless telephones may be equipped with other forms of operating systems such as real-time operating systems (“RTOS”) or Palm Computing's PalmOS™.

A set of basic input and output functions (“BIOS”) and hardware device drivers (221) are often provided to allow the operating system (220) and programs to interface to and control the specific hardware functions provided with the computing platform.

Additionally, one or more embedded firmware programs (222) are commonly provided with many computing platforms, which are executed by onboard or “embedded” microprocessors as part of the peripheral device, such as a micro controller or a hard drive, a communication processor, network interface card, or sound or graphics card.

As such, FIGS. 2a and 2b describe in a general sense the various hardware components, software and firmware programs of a wide variety of computing platforms, including but not limited to personal computers, PDAs, PIMs, web-enabled telephones, and other appliances such as WebTV™ units. As such, we now turn our attention to disclosure of the present invention relative to the processes and methods preferably implemented as software and firmware on such a computing platform. It will be readily recognized by those skilled in the art that the following methods and processes may be alternatively realized as hardware functions, in part or in whole, without departing from the spirit and scope of the invention.

### Service-Based Embodiments

Alternative embodiments of the present invention include some or all of the foregoing logical processes and functions of the invention being provided by configuring software, deploying software, downloading software, distributing software, or remotely serving clients in an on demand environment.

Software Deployment Embodiment. According to one embodiment of the invention, the methods and processes of the invention are distributed or deployed as a service by a service provider to a client's computing system(s).

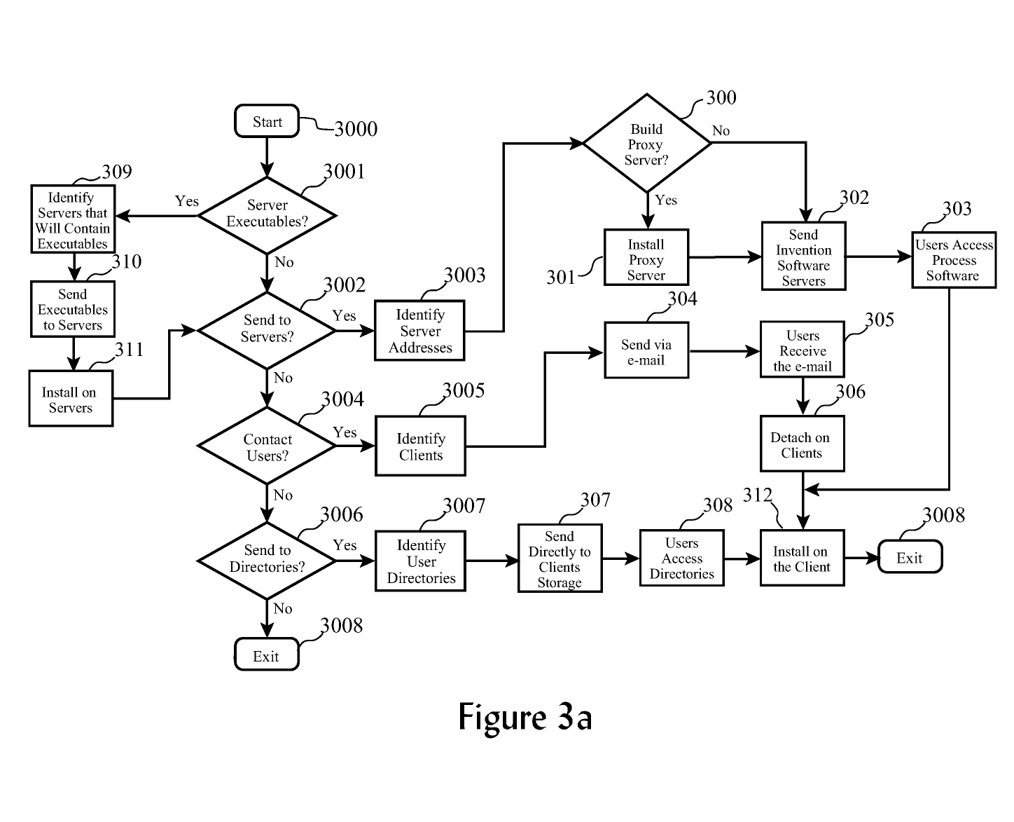

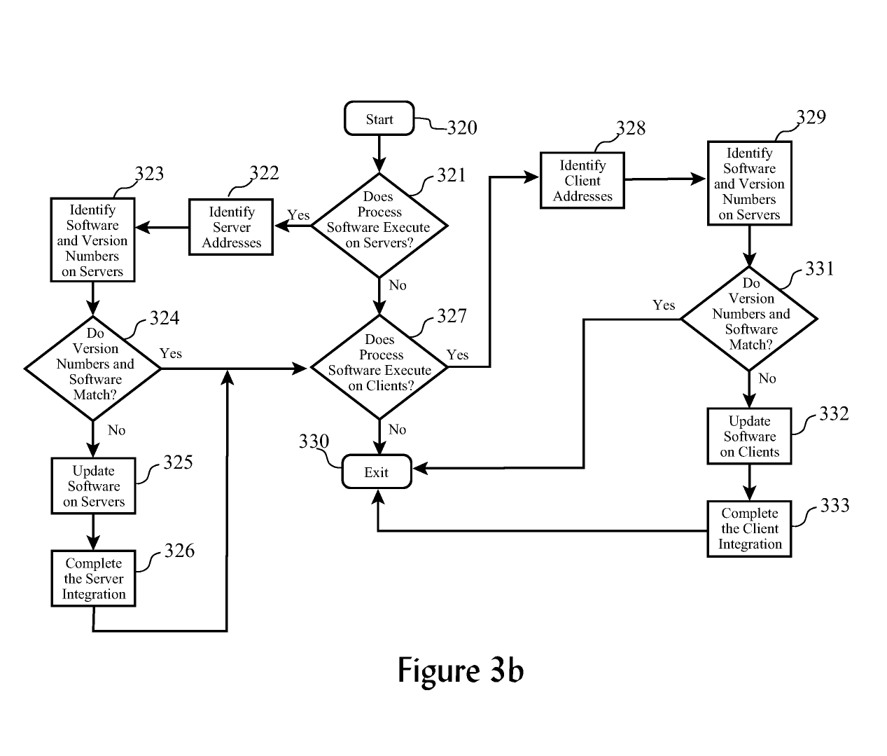

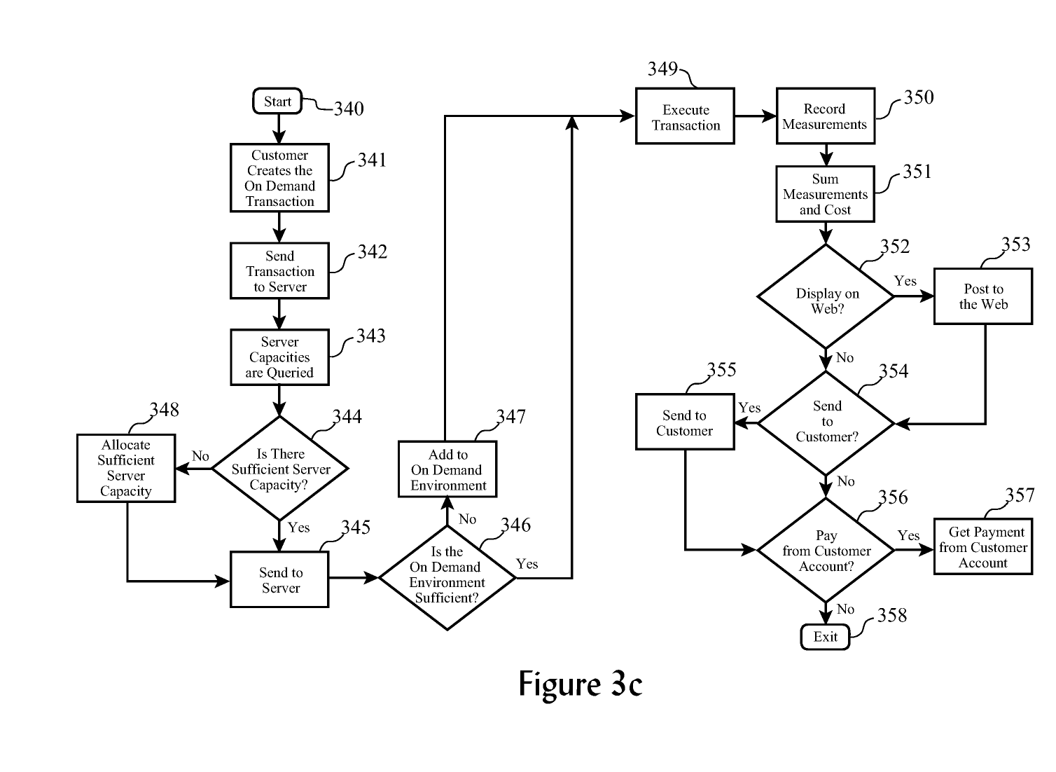

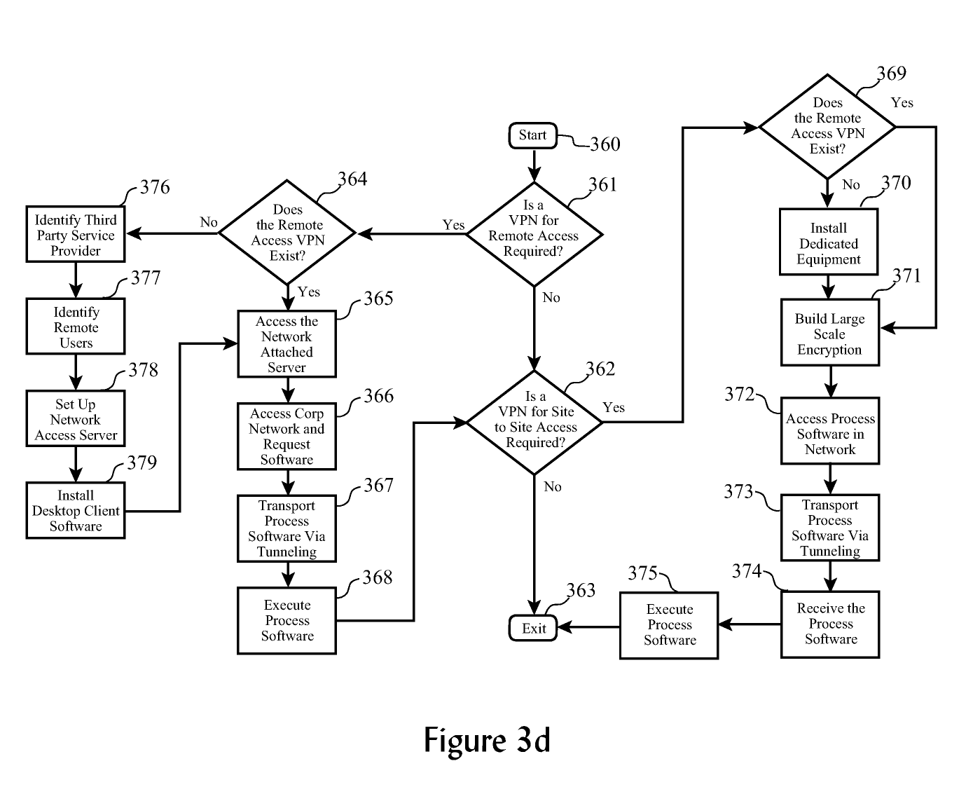

Turning to FIG. 3a, the deployment process begins (3000) by determining (3001) if there are any programs that will reside on a server or servers when the process software is executed. If this is the case, then the servers that will contain the executables are identified (309). The process software for the server or servers is transferred directly to the servers storage via FTP or some other protocol or by copying through the use of a shared files system (310). The process software is then installed on the servers (311).

Next, a determination is made on whether the process software is to be deployed by having users access the process software on a server or servers (3002). If the users are to access the process software on servers, then the server addresses that will store the process software are identified (3003).

In step (3004) a determination is made whether the process software is to be developed by sending the process software to users via e-mail. The set of users where the process software will be deployed are identified together with the addresses of the user client computers (3005). The process software is sent via e-mail to each of the user's client computers. The users then receive the e-mail (305) and then detach the process software from the e-mail to a directory on their client computers (306). The user executes the program that installs the process software on his client computer (312) then exits the process (3008).

A determination is made if a proxy server is to be built (300) to store the process software. A proxy server is a server that sits between a client application, such as a Web browser, and a real server. It intercepts all requests to the real server to see if it can fulfill the requests itself. If not, it forwards the request to the real server. The two primary benefits of a proxy server are to improve performance and to filter requests. If a proxy server is required then the proxy server is installed (301). The process software is sent to the servers either via a protocol such as FTP or it is copied directly from the source files to the server files via file sharing (302). Another embodiment would be to send a transaction to the servers that contained the process software and have the server process the transaction, then receive and copy the process software to the server's file system. Once the process software is stored at the servers, the users via their client computers, then access the process software on the servers and copy to their client computers file systems (303). Another embodiment is to have the servers automatically copy the process software to each client and then run the installation program for the process software at each client computer. The user executes the program that installs the process software on his client computer (312) then exits the process (3008).

Lastly, a determination is made on whether the process software will be sent directly to user directories on their client computers (3006). If so, the user directories are identified (3007). The process software is transferred directly to the user's client computer directory (307). This can be done in several ways such as, but not limited to, sharing of the file system directories and then copying from the sender's file system to the recipient user's file system or alternatively using a transfer protocol such as File Transfer Protocol (“FTP”). The users access the directories on their client file systems in preparation for installing the process software (308). The user executes the program that installs the process software on his client computer (312) then exits the process (3008).

Software Integration Embodiment. According to another embodiment of the present invention, software embodying the methods and processes disclosed herein are integrated as a service by a service provider to other software applications, applets, or computing systems.

Integration of the invention generally includes providing for the process software to coexist with applications, operating systems and network operating systems software and then installing the process software on the clients and servers in the environment where the process software will function.

Generally speaking, the first task is to identify any software on the clients and servers including the network operating system where the process software will be deployed that are required by the process software or that work in conjunction with the process software. This includes the network operating system that is software that enhances a basic operating system by adding networking features. Next, the software applications and version numbers will be identified and compared to the list of software applications and version numbers that have been tested to work with the process software. Those software applications that are missing or that do not match the correct version will be upgraded with the correct version numbers. Program instructions that pass parameters from the process software to the software applications will be checked to ensure the parameter lists matches the parameter lists required by the process software. Conversely parameters passed by the software applications to the process software will be checked to ensure the parameters match the parameters required by the process software. The client and server operating systems including the network operating systems will be identified and compared to the list of operating systems, version numbers and network software that have been tested to work with the process software. Those operating systems, version numbers and network software that do not match the list of tested operating systems and version numbers will be upgraded on the clients and servers to the required level.

After ensuring that the software, where the process software is to be deployed, is at the correct version level that has been tested to work with the process software, the integration is completed by installing the process software on the clients and servers.

Turning to FIG. 3b, details of the integration process according to the invention are shown. Integrating begins (320) by determining if there are any process software programs that will execute on a server or servers (321). If this is not the case, then integration proceeds to (327). If this is the case, then the server addresses are identified (322). The servers are checked to see if they contain software that includes the operating system (“OS”), applications, and network operating systems (“NOS”), together with their version numbers, that have been tested with the process software (323). The servers are also checked to determine if there is any missing software that is required by the process software (323).

A determination is made if the version numbers match the version numbers of OS, applications and NOS that have been tested with the process software (324). If all of the versions match and there is no missing required software the integration continues in (327).

If one or more of the version numbers do not match, then the unmatched versions are updated on the server or servers with the correct versions (325). Additionally, if there is missing required software, then it is updated on the server or servers (325). The server integration is completed by installing the process software (326).

Step (327) which follows either (321), (324), or (326) determines if there are any programs of the process software that will execute on the clients. If no process software programs execute on the clients, the integration proceeds to (330) and exits. If this is not the case, then the client addresses are identified (328).

The clients are checked to see if they contain software that includes the operating system (“OS”), applications, and network operating systems (“NOS”), together with their version numbers, that have been tested with the process software (329). The clients are also checked to determine if there is any missing software that is required by the process software (329).

A determination is made if the version numbers match the version numbers of OS, applications and NOS that have been tested with the process software 331. If all of the versions match and there is no missing required software, then the integration proceeds to (330) and exits.

If one or more of the version numbers do not match, then the unmatched versions are updated on the clients with the correct versions (332). In addition, if there is missing required software then it is updated on the clients (332). The client integration is completed by installing the process software on the clients (333). The integration proceeds to (330) and exits.

Application Programming Interface Embodiment. In another embodiment, the invention may be realized as a service or functionality available to other systems and devices via an Application Programming Interface (“API”). One such embodiment is to provide the service to a client system from a server system as a web service.

On-Demand Computing Services Embodiment. According to another aspect of the present invention, the processes and methods disclosed herein are provided through an on demand computing architecture to render service to a client by a service provider.

Turning to FIG. 3c, generally speaking, the process software embodying the methods disclosed herein is shared, simultaneously serving multiple customers in a flexible, automated fashion. It is standardized, requiring little customization and it is scaleable, providing capacity on demand in a pay-as-you-go model.

The process software can be stored on a shared file system accessible from one or more servers. The process software is executed via transactions that contain data and server processing requests that use CPU units on the accessed server. CPU units are units of time such as minutes, seconds, hours on the central processor of the server. Additionally, the assessed server may make requests of other servers that require CPU units. CPU units are an example that represents but one measurement of use. Other measurements of use include but are not limited to network bandwidth, memory usage, storage usage, packet transfers, complete transactions, etc.

When multiple customers use the same process software application, their transactions are differentiated by the parameters included in the transactions that identify the unique customer and the type of service for that customer. All of the CPU units and other measurements of use that are used for the services for each customer are recorded. When the number of transactions to any one server reaches a number that begins to effect the performance of that server, other servers are accessed to increase the capacity and to share the workload. Likewise, when other measurements of use such as network bandwidth, memory usage, storage usage, etc. approach a capacity so as to effect performance, additional network bandwidth, memory usage, storage etc. are added to share the workload.

The measurements of use used for each service and customer are sent to a collecting server that sums the measurements of use for each customer for each service that was processed anywhere in the network of servers that provide the shared execution of the process software. The summed measurements of use units are periodically multiplied by unit costs and the resulting total process software application service costs are alternatively sent to the customer and or indicated on a web site accessed by the computer which then remits payment to the service provider.

In another embodiment, the service provider requests payment directly from a customer account at a banking or financial institution.

In another embodiment, if the service provider is also a customer of the customer that uses the process software application, the payment owed to the service provider is reconciled to the payment owed by the service provider to minimize the transfer of payments.

FIG. 3c sets forth a detailed logical process which makes the present invention available to a client through an On-Demand process. A transaction is created that contains the unique customer identification, the requested service type and any service parameters that further specify the type of service (341). The transaction is then sent to the main server (342). In an On-Demand environment the main server can initially be the only server, then as capacity is consumed other servers are added to the On-Demand environment.

The server central processing unit (“CPU”) capacities in the On-Demand environment are queried (343). The CPU requirement of the transaction is estimated, then the servers available CPU capacity in the On-Demand environment are compared to the transaction CPU requirement to see if there is sufficient CPU available capacity in any server to process the transaction (344). If there is not sufficient server CPU available capacity, then additional server CPU capacity is allocated to process the transaction (348). If there was already sufficient available CPU capacity, then the transaction is sent to a selected server (345).

Before executing the transaction, a check is made of the remaining On-Demand environment to determine if the environment has sufficient available capacity for processing the transaction. This environment capacity consists of such things as, but not limited to, network bandwidth, processor memory, storage etc.

(345). If there is not sufficient available capacity, then capacity will be added to the On-Demand environment (347). Next, the required software to process the transaction is accessed, loaded into memory, then the transaction is executed (349).

The usage measurements are recorded (350). The usage measurements consists of the portions of those functions in the On-Demand environment that are used to process the transaction. The usage of such functions as, but not limited to, network bandwidth, processor memory, storage and CPU cycles are what is recorded. The usage measurements are summed, multiplied by unit costs and then recorded as a charge to the requesting customer (351).

If the customer has requested that the On-Demand costs be posted to a web site (352), then they are posted (353). If the customer has requested that the On-Demand costs be sent via e-mail to a customer address (354), then they are sent (355). If the customer has requested that the On-Demand costs be paid directly from a customer account (356), then payment is received directly from the customer account (357). The last step is to exit the On-Demand process.

Grid or Parallel Processing Embodiment. According to another embodiment of the present invention, multiple computers are used to simultaneously process individual audio tracks, individual audio snippets, or a combination of both, to yield output with less delay. Such a parallel computing approach may be realized using multiple discrete systems (e.g. a plurality of servers, clients, or both), or may be realized as an internal multiprocessing task (e.g. a single system with parallel processing capabilities).

VPN Deployment Embodiment. According to another aspect of the present invention, the methods and processes described herein may be embodied in part or in entirety in software which can be deployed to third parties as part of a service, wherein a third party VPN service is offered as a secure deployment vehicle or wherein a VPN is build on-demand as required for a specific deployment.

A virtual private network (“VPN”) is any combination of technologies that can be used to secure a connection through an otherwise unsecured or untrusted network. VPNs improve security and reduce operational costs. The VPN makes use of a public network, usually the Internet, to connect remote sites or users together. Instead of using a dedicated, real-world connection such as leased line, the VPN uses “virtual” connections routed through the Internet from the company's private network to the remote site or employee. Access to the software via a VPN can be provided as a service by specifically constructing the VPN for purposes of delivery or execution of the process software (i.e. the software resides elsewhere) wherein the lifetime of the VPN is limited to a given period of time or a given number of deployments based on an amount paid.

The process software may be deployed, accessed and executed through either a remote-access or a site-to-site VPN. When using the remote-access VPNs the process software is deployed, accessed and executed via the secure, encrypted connections between a company's private network and remote users through a third-party service provider. The enterprise service provider (“ESP”) sets a network access server (“NAS”) and provides the remote users with desktop client software for their computers. The telecommuters can then dial a toll-free number to attach directly via a cable or DSL modem to reach the NAS and use their VPN client software to access the corporate network and to access, download and execute the process software.

When using the site-to-site VPN, the process software is deployed, accessed and executed through the use of dedicated equipment and large-scale encryption that are used to connect a company's multiple fixed sites over a public network such as the Internet.

The process software is transported over the VPN via tunneling which is the process of placing an entire packet within another packet and sending it over the network. The protocol of the outer packet is understood by the network and both points, called tunnel interfaces, where the packet enters and exits the network.

Turning to FIG. 3d, VPN deployment process starts (360) by determining if a VPN for remote access is required (361). If it is not required, then proceed to (362). If it is required, then determine if the remote access VPN exits (364).

If a VPN does exist, then the VPN deployment process proceeds (365) to identify a third party provider that will provide the secure, encrypted connections between the company's private network and the company's remote users (376). The company's remote users are identified (377). The third party provider then sets up a network access server (“NAS”) (378) that allows the remote users to dial a toll free number or attach directly via a broadband modem to access, download and install the desktop client software for the remote-access VPN (379).

After the remote access VPN has been built or if it has been previously installed, the remote users can access the process software by dialing into the NAS or attaching directly via a cable or DSL modem into the NAS (365). This allows entry into the corporate network where the process software is accessed (366). The process software is transported to the remote user's desktop over the network via tunneling. That is the process software is divided into packets and each packet including the data and protocol is placed within another packet (367). When the process software arrives at the remote user's desktop, it is removed from the packets, reconstituted and then is executed on the remote users desktop (368).

A determination is made to see if a VPN for site to site access is required (362). If it is not required, then proceed to exit the process (363). Otherwise, determine if the site to site VPN exists (369). If it does exist, then proceed to (372). Otherwise, install the dedicated equipment required to establish a site to site VPN (370). Then, build the large scale encryption into the VPN (371).

After the site to site VPN has been built or if it had been previously established, the users access the process software via the VPN (372). The process software is transported to the site users over the network via tunneling. That is the process software is divided into packets and each packet including the data and protocol is placed within another packet (374). When the process software arrives at the remote user's desktop, it is removed from the packets, reconstituted and is executed on the site users desktop (375). Proceed to exit the process (363).

### Computer-Readable Media Embodiments

In another embodiment of the invention, logical processes according to the invention and described herein are encoded on or in one or more computer-readable media. Some computer-readable media are read-only (e.g. they must be initially programmed using a different device than that which is ultimately used to read the data from the media), some are write-only (e.g. from the data encoders perspective they can only be encoded, but not read simultaneously), or read-write. Still some other media are write-once, read-many-times.

Some media are relatively fixed in their mounting mechanisms, while others are removable, or even transmittable. All computer-readable media form two types of systems when encoded with data and/or computer software: (a) when removed from a drive or reading mechanism, they are memory devices which generate useful data-driven outputs when stimulated with appropriate electromagnetic, electronic, and/or optical signals; and (b) when installed in a drive or reading device, they form a data repository system accessible by a computer.

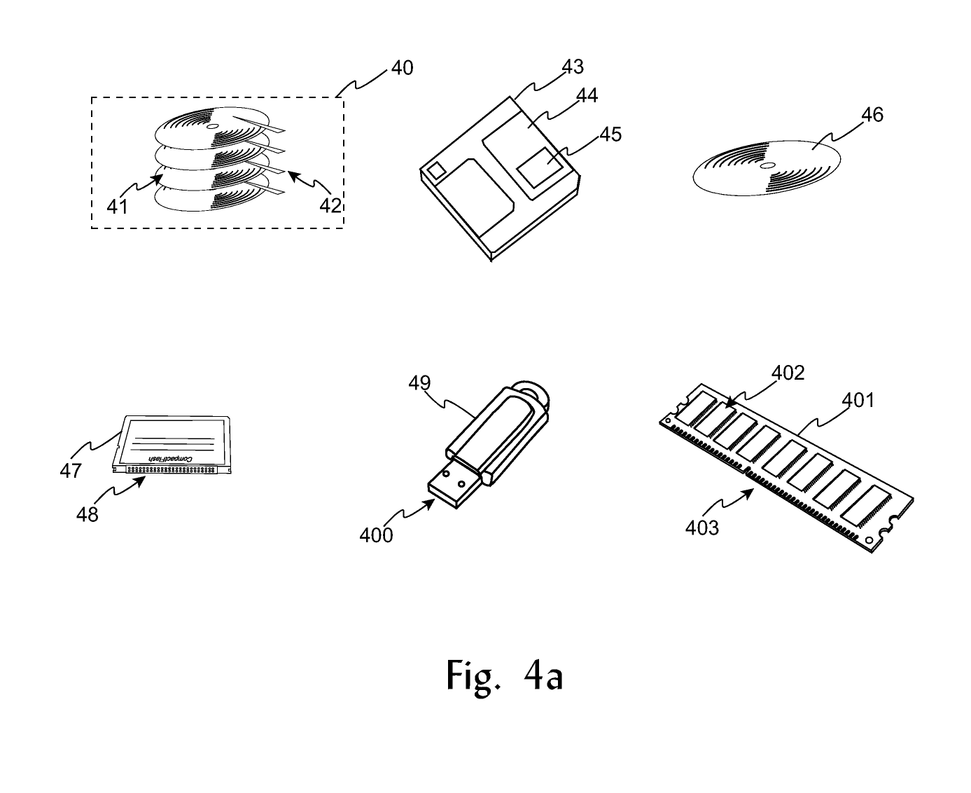

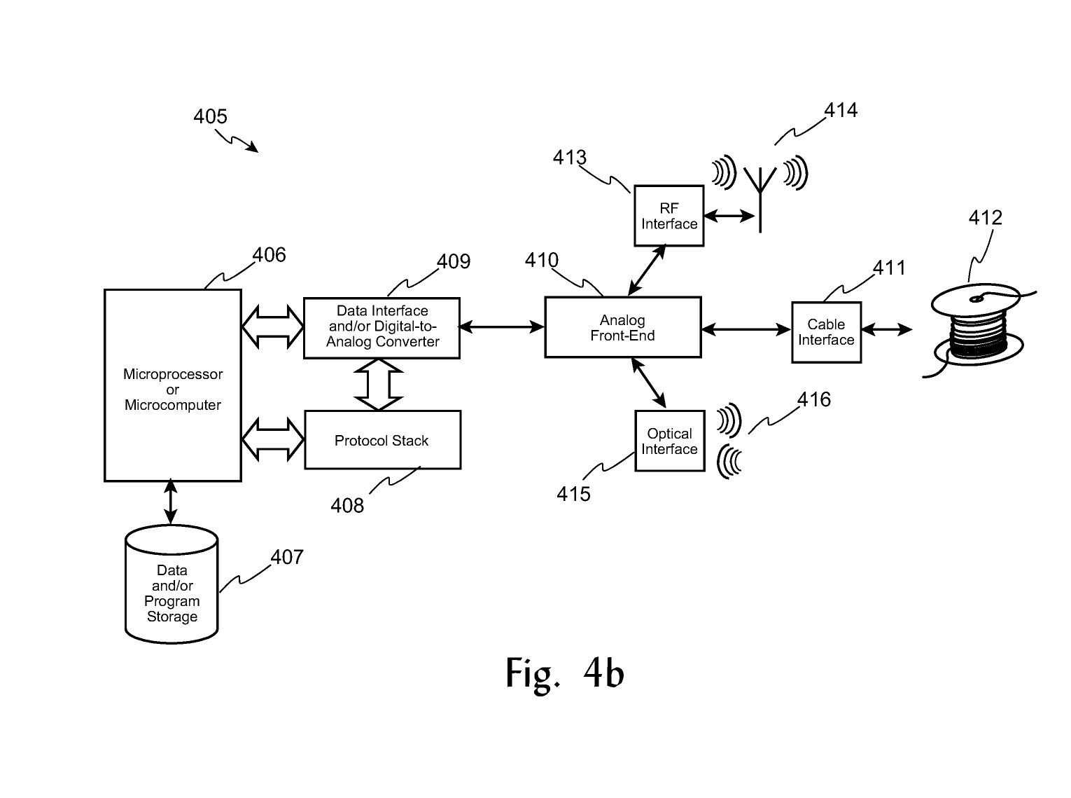

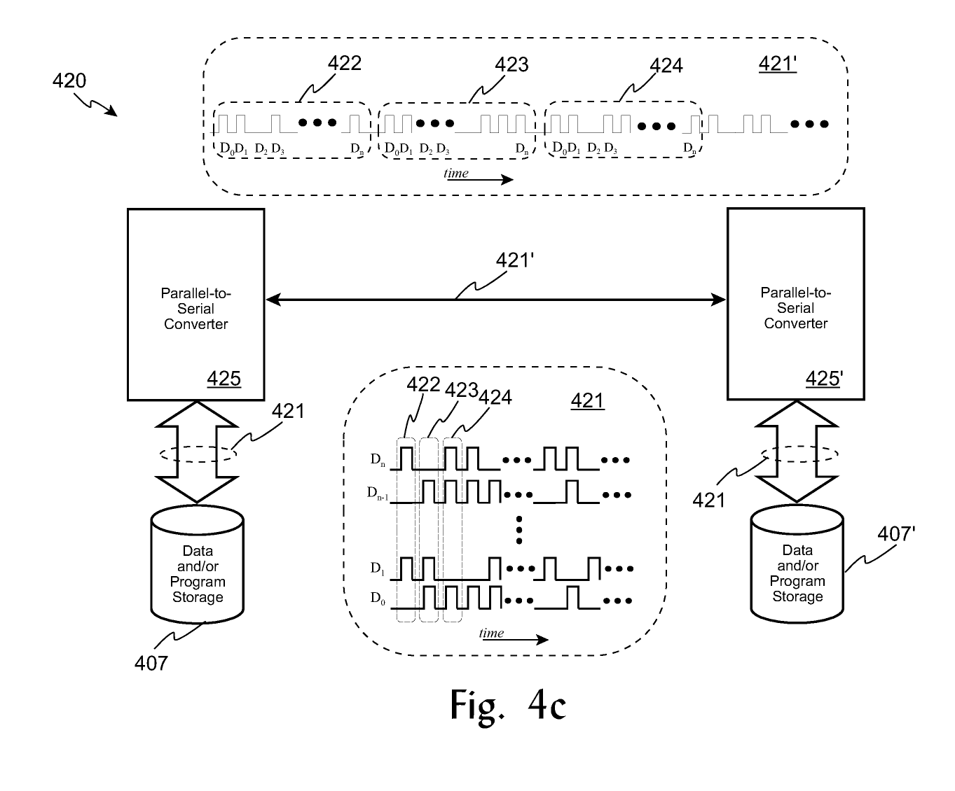

FIG. 4a illustrates some computer readable media including a computer hard drive (40) having one or more magnetically encoded platters or disks (41), which may be read, written, or both, by one or more heads (42). Such hard drives are typically semi-permanently mounted into a complete drive unit, which may then be integrated into a configurable computer system such as a Personal Computer, Server Computer, or the like.

Similarly, another form of computer readable media is a flexible, removable “floppy disk” (43), which is inserted into a drive which houses an access head. The floppy disk typically includes a flexible, magnetically encodable disk which is accessible by the drive head through a window (45) in a sliding cover (44).

A Compact Disk (“CD”) (46) is usually a plastic disk which is encoded using an optical and/or magneto-optical process, and then is read using generally an optical process. Some CD's are read-only (“CD-ROM”), and are mass produced prior to distribution and use by reading-types of drives. Other CD's are writable (e.g. “CD-RW”, “CD-R”), either once or many time. Digital Versatile Disks (“DVD”) are advanced versions of CD's which often include double-sided encoding of data, and even multiple layer encoding of data. Like a floppy disk, a CD or DVD is a removable media.

Another common type of removable media are several types of removable circuit-based (e.g. solid state) memory devices, such as Compact Flash (“CF”) (47), Secure Data (“SD”), Sony's MemoryStick, Universal Serial Bus (“USB”) FlashDrives and “Thumbdrives” (49), and others. These devices are typically plastic housings which incorporate a digital memory chip, such as a battery-backed random access chip (“RAM”), or a Flash Read-Only Memory (“FlashROM”). Available to the external portion of the media is one or more electronic connectors (48, 400) for engaging a connector, such as a CF drive slot or a USB slot. Devices such as a USB FlashDrive are accessed using a serial data methodology, where other devices such as the CF are accessed using a parallel methodology. These devices often offer faster access times than disk-based media, as well as increased reliability and decreased susceptibility to mechanical shock and vibration. Often, they provide less storage capability than comparably priced disk-based media.

Yet another type of computer readable media device is a memory module (403), often referred to as a SIMM or DIMM. Similar to the CF, SD, and FlashDrives, these modules incorporate one or more memory devices (402), such as Dynamic RAM (“DRAM”), mounted on a circuit board (401) having one or more electronic connectors for engaging and interfacing to another circuit, such as a Personal Computer motherboard. These types of memory modules are not usually encased in an outer housing, as they are intended for installation by trained technicians, and are generally protected by a larger outer housing such as a Personal Computer chassis.

Turning now to FIG. 4b, another embodiment option (405) of the present invention is shown in which a computer-readable signal is encoded with software, data, or both, which implement logical processes according to the invention. FIG. 4b is generalized to represent the functionality of wireless, wired, electro-optical, and optical signaling systems. For example, the system shown in FIG. 4b can be realized in a manner suitable for wireless transmission over Radio Frequencies (“RF”), as well as over optical signals, such as InfraRed Data Arrangement (“IrDA”). The system of FIG. 4b may also be realized in another manner to serve as a data transmitter, data receiver, or data transceiver for a USB system, such as a drive to read the aforementioned USB FlashDrive, or to access the serially-stored data on a disk, such as a CD or hard drive platter.

In general, a microprocessor or microcontroller (406) reads, writes, or both, data to/from storage for data, program, or both (407). A data interface (409), optionally including a digital-to-analog converter, cooperates with an optional protocol stack (408), to send, receive, or transceive data between the system front-end (410) and the microprocessor (406). The protocol stack is adapted to the signal type being sent, received, or transceived. For example, in a Local Area Network (“LAN”) embodiment, the protocol stack may implement Transmission Control Protocol/Internet Protocol (“TCP/IP”). In a computer-to-computer or computer-to-periperal embodiment, the protocol stack may implement all or portions of USB, “FireWire”, RS-232, Point-to-Point Protocol (“PPP”), etc.

The system's front-end, or analog front-end, is adapted to the signal type being modulated, demodulate, or transcoded. For example, in an RF-based (413) system, the analog front-end comprises various local oscillators, modulators, demodulators, etc., which implement signaling formats such as Frequency Modulation (“FM”), Amplitude Modulation (“AM”), Phase Modulation (“PM”), Pulse Code Modulation (“PCM”), etc. Such an RF-based embodiment typically includes an antenna (414) for transmitting, receiving, or transceiving electro-magnetic signals via open air, water, earth, or via RF wave guides and coaxial cable. Some common open air transmission standards are BlueTooth, Global Services for Mobile Communications (“GSM”), Time Division Multiple Access (“TDMA”), Advanced Mobile Phone Service (“AMPS”), and Wireless Fidelity (“Wi-Fi”).

In another example embodiment, the analog front-end may be adapted to sending, receiving, or transceiving signals via an optical interface (415), such as laser-based optical interfaces (e.g. Wavelength Division Multiplexed, SONET, etc.), or Infra Red Data Arrangement (“IrDA”) interfaces (416). Similarly, the analog front-end may be adapted to sending, receiving, or transceiving signals via cable (412) using a cable interface, which also includes embodiments such as USB, Ethernet, LAN, twisted-pair, coax, Plain-old Telephone Service (“POTS”), etc.

Signals transmitted, received, or transceived, as well as data encoded on disks or in memory devices, may be encoded to protect it from unauthorized decoding and use. Other types of encoding may be employed to allow for error detection, and in some cases, correction, such as by addition of parity bits or Cyclic Redundancy Codes (“CRC”). Still other types of encoding may be employed to allow directing or “routing” of data to the correct destination, such as packet and frame-based protocols.

FIG. 4c illustrates conversion systems which convert parallel data to and from serial data. Parallel data is most often directly usable by microprocessors, often formatted in 8-bit wide bytes, 16-bit wide words, 32-bit wide double words, etc. Parallel data can represent executable or interpretable software, or it may represent data values, for use by a computer. Data is often serialized in order to transmit it over a media, such as a RF or optical channel, or to record it onto a media, such as a disk. As such, many computer-readable media systems include circuits, software, or both, to perform data serialization and re-parallelization.

Parallel data (421) can be represented as the flow of data signals aligned in time, such that parallel data unit (byte, word, d-word, etc.) (422, 423, 424) is transmitted with each bit D₀-Dₙ being on a bus or signal carrier simultaneously, where the “width” of the data unit is n−1. In some systems, D₀ is used to represent the least significant bit (“LSB”), and in other systems, it represents the most significant bit (“MSB”). Data is serialized (421) by sending one bit at a time, such that each data unit (422, 423, 424) is sent in serial fashion, one after another, typically according to a protocol.

As such, the parallel data stored in computer memory (407, 407′) is often accessed by a microprocessor or Parallel-to-Serial Converter (425, 425′) via a parallel bus (421), and exchanged (e.g. transmitted, received, or transceived) via a serial bus (421′). Received serial data is converted back into parallel data before storing it in computer memory, usually. The serial bus (421′) generalized in FIG. 4c may be a wired bus, such as USB or Firewire, or a wireless communications medium, such as an RF or optical channel, as previously discussed.

In these manners, various embodiments of the invention may be realized by encoding software, data, or both, according to the logical processes of the invention, into one or more computer-readable mediums, thereby yielding a product of manufacture and a system which, when properly read, received, or decoded, yields useful programming instructions, data, or both, including, but not limited to, the computer-readable media types described in the foregoing paragraphs.

### CONCLUSION

While certain examples and details of a certain embodiments have been disclosed, it will be recognized by those skilled in the are that variations in implementation such as use of different programming methodologies, computing platforms, and processing technologies, may be adopted without departing from the spirit and scope of the present invention. Therefore, the scope of the invention should be determined by the following claims.

What is claimed is:

1. A system comprising:
at least one wireless identification tag, each of which is affixed to one or more travel items deemed by user to be important travel items, each tag having a unique identifier;
one or more jurisdictional travel item restrictions list;
an wireless identification tag reader; and
a computing device configured to access said user-created list and said restrictions list, to receive said unique identifiers from said tags via said tag reader upon user operation by scanning contents of one or more travel containers, to verify which if any items on said restricted list are found during said scan, to notify said user of said found restricted items.

2. The system as set forth in claim 1 wherein said computing device comprises a device selected from the group of a cellular telephone, a personal digital assistant, and a portable computer.

3. The system as set forth in claim 1 wherein further comprising at least one wireless identification tag associated with a travel container, and wherein said computing device is further configured to differentiate between allowed container location of said restricted items.

4. The system as set forth in claim 3 wherein said differentiation comprises an indication of whether a restricted item can be present in a checked container.

5. The system as set forth in claim 3 wherein said differentiation comprises an indication of whether a restricted item can be present in a container carried on board a transportation vehicle by a passenger.

6. The system as set forth in claim 1 further comprising an electronic travel itinerary accessed by said computing device, and wherein said computing device is further configured to determine jurisdictions of potential container inspection, and to access jurisdictional restriction lists associated with said determined jurisdictions of potential container inspection.

7. An automated method comprising:
providing a list of important travel items having descriptions of said travel items associated with unique identifiers corresponding to wireless identification tags affixed to each of said travel items deemed by user to be important travel items;
providing one or more jurisdictional travel item restrictions list;
upon operation by user of a computing device equipped with a reader for said identification tag which:
(a) accessing said user-created list and said restrictions list;
(b) scanning one or more tagged items packed in one or more travel containers to receive said unique identifiers from said tags;
(c) verifying if any items on said restrictions list are found during said scan; and
(d) notifying said user of said found restricted items.

8. The method as set forth in claim 7 wherein said step of operating a computing device comprises operating a device selected from the group of a cellular telephone, a personal digital assistant, and a portable computer.

9. The method as set forth in claim 7 wherein said step of operating a computer device further comprises scanning at least one wireless identification tag associated with a travel container, and differentiating between allowed container location of said restricted items.

10. The method as set forth in claim 9 wherein said step of differentiating comprises an accessing an indication of whether a restricted item can be present in a checked container.

11. The method as set forth in claim 9 wherein said step of differentiating comprises accessing an indication of whether a restricted item can be present in a container carried on board a transportation vehicle by a passenger.

12. The method as set forth in claim 7 further wherein said step of operating a computer device further comprises accessing an electronic travel itinerary, determining jurisdictions of potential container inspection along a planned path of travel, and accessing jurisdictional restriction lists associated with said determined jurisdictions of potential container inspection.

13. An article of manufacture comprising:
a computer-readable medium suitable for storing software; and
one or more programs stored by said computer-readable medium configured to cause a process to perform the steps of:
(a) providing a list of important travel items having descriptions of said travel items associated with unique identifiers corresponding to wireless identification tags affixed to each of said travel items deemed by user to be important travel items;
(b) providing one or more jurisdictional travel item restrictions list; and
(c) upon operation by user of a computing device equipped with a reader for said identification tag:
(1) accessing said user-created list and said restrictions list;
(2) scanning one or more tagged items packed in one or more travel containers to receive said unique identifiers from said tags;
(3) verifying if any items on said restrictions list are found during said scan; and
(4) notifying said user of said found restricted items.

14. The article as set forth in claim 13 wherein said step of operating a computing device comprises operating a device selected from the group of a cellular telephone, a personal digital assistant, and a portable computer.

15. The article as set forth in claim 7 wherein said step of operating a computer device further comprises scanning at least one wireless identification tag associated with a travel container, and differentiating between allowed container location of said restricted items.

16. The article as set forth in claim 15 wherein said step of differentiating comprises an accessing an indication of whether a restricted item can be present in a checked container.

17. The article as set forth in claim 15 wherein said step of differentiating comprises accessing an indication of whether a restricted item can be present in a container carried on board a transportation vehicle by a passenger.

18. The article as set forth in claim 7 further wherein said step of operating a computer device further comprises accessing an electronic travel itinerary, determining jurisdictions of potential container inspection along a planned path of travel, and accessing jurisdictional restriction lists associated with said determined jurisdictions of potential container inspection.
